(19) United States
(12) Patent Application Publication
(10) Pub. No.: US 2021/0150335 A1
(43) Pub. Date: May 20, 2021

(54) PREDICTIVE MODEL PERFORMANCE EVALUATION

(71) Applicant: International Business Machines Corporation, Armonk, NY (US)

(72) Inventors: LUKASZ G. CMIELOWSKI, KRAKOW (PL); RAFAL BIGAJ, KRAKOW (PL); MAKSYMILIAN ERAZMUS, Zasow (PL); Wojciech Sobala, KRAKOW (PL)

(21) Appl. No.: 16/689,374

(22) Filed: Nov. 20, 2019

(51) Int. Cl. G06N 3/08; G06N 3/04

(52) U.S. Cl. CPC G06N 3/08; G06F 17/15; G06N 3/04

(57) ABSTRACT

A key performance indicator is defined. A plurality of transaction datasets is received. A set of data fields in each transaction dataset of the plurality is tagged. A subset of the plurality is identified, by data field tag. A first key performance indicator metric is calculated using the subset. A first set of predictive model metrics is calculated using the subset. A first correlation coefficient between the first key performance indicator metric and the first set of predictive model metrics is determined. A second key performance indicator metric is calculated using the plurality. A second set of predictive model metrics is calculated using the plurality. A second correlation coefficient between the second key performance indicator metric and the second set of predictive model metrics is determined. An evaluation for the key performance indicator is determined. A user is notified of the evaluation.

### BACKGROUND

This disclosure relates generally to predictive models, and more particularly, to evaluating the performance of a predictive model.

Predictive models enjoy widespread use and myriad applications, and the complexity and size of the ingested datasets continue to increase. Large datasets provide challenges for predictive models. While a given metric for evaluating a predictive model may indicate a desirable level of overall performance, the predictive model may not always achieve that level of performance when the dataset is divided into subgroups. In other words, the prediction may not match or correlate a subset or facet of the ingested data.

Prior methods may employ statistical manipulation of a dataset to find or force trend lines in 2D models or data point clusters in 3D models to find correlations between the output/prediction of predictive models and observable trends within the datasets they ingest. Determining which trend line or cluster most accurately describes the “real” trend, or cause for the trend, may not be possible.

There is a need for a way to ensure a predictive model performs well and to identify true trends, regardless of the metric used to evaluate performance (i.e., accuracy vs. precision vs. robustness, etc.), and regardless of how a dataset is divided or whether the trend is observable or not.

### SUMMARY

An embodiment is directed to a method for evaluating the performance of a predictive model. A key performance indicator is defined. A plurality of transaction datasets is received. A set of data fields in each transaction dataset of the plurality of transaction datasets is tagged. A subset of the plurality of transaction datasets is identified, according to a first data field tag. A first key performance indicator metric is calculated using the subset of the plurality of transaction datasets. A first set of predictive model metrics is calculated using the subset of the plurality of transaction datasets. A first correlation coefficient between the first key performance indicator metric and the first set of predictive model metrics is determined. A second key performance indicator metric is calculated using the plurality of transaction datasets. A second set of predictive model metrics is calculated using the plurality of transaction datasets. A second correlation coefficient between the second key performance indicator metric and the second set of predictive model metrics is determined. An evaluation for the key performance indicator is determined, based on the first and second correlation coefficient. A user is notified of the evaluation. The method may adjust the predictive model, based on the evaluation. The method may consider accuracy, fairness, robustness, and overall performance in the first and second set of predictive model metrics. The method may include detecting a discrepancy between the first correlation coefficient and the second correlation coefficient. The method may include a determination that a first predictive model metric caused the discrepancy. The method may include employing, as part of the predictive model, a neural network to generate one or more predictions associated with the key performance indicator. The method may include adjusting a weight and a bias of one or more neural network edges when generating the one or more predictions.

Another embodiment is directed to a computer program product for evaluating the performance of a predictive model. The computer program product comprises a computer readable storage medium having program instructions embodied therewith, and the program instructions are executable by a device. The program instructions cause the device to perform the following steps. A key performance indicator is defined. A plurality of transaction datasets is received. A set of data fields in each transaction dataset of the plurality of transaction datasets is tagged. A subset of the plurality of transaction datasets is identified, according to a first data field tag. A first key performance indicator metric is calculated using the subset of the plurality of transaction datasets. A first set of predictive model metrics is calculated using the subset of the plurality of transaction datasets. A first correlation coefficient between the first key performance indicator metric and the first set of predictive model metrics is determined. A second key performance indicator metric is calculated using the plurality of transaction datasets. A second set of predictive model metrics is calculated using the plurality of transaction datasets. A second correlation coefficient between the second key performance indicator metric and the second set of predictive model metrics is determined. An evaluation for the key performance indicator is determined, based on the first and second correlation coefficient. A user is notified of the evaluation. The program instructions may further adjust the predictive model, based on the evaluation. The program instructions may consider accuracy, fairness, robustness, and overall performance in the first and second set of predictive model metrics. The program instructions may include detecting a discrepancy between the first correlation coefficient and the second correlation coefficient. The program instructions may include a determination that a first predictive model metric caused the discrepancy. The program instructions may include employing, as part of the predictive model, a neural network to generate one or more predictions associated with the key performance indicator. The program instructions may include adjusting a weight and a bias of one or more neural network edges when generating the one or more predictions.

Yet another embodiment is directed to a system for evaluating the performance of a predictive model. The system comprises a memory with program instructions included thereon and a processor in communication with the memory. The program instructions cause the device to perform the following steps. A key performance indicator is defined. A plurality of transaction datasets is received. A set of data fields in each transaction dataset of the plurality of transaction datasets is tagged. A subset of the plurality of transaction datasets is identified, according to a first data field tag. A first key performance indicator metric is calculated using the subset of the plurality of transaction datasets. A first set of predictive model metrics is calculated using the subset of the plurality of transaction datasets. A first correlation coefficient between the first key performance indicator metric and the first set of predictive model metrics is determined. A second key performance indicator metric is calculated using the plurality of transaction datasets. A second set of predictive model metrics is calculated using the plurality of transaction datasets. A second correlation coefficient between the second key performance indicator metric and the second set of predictive model metrics is determined. An evaluation for the key performance indicator is determined, based on the first and second correlation coefficient. A user is notified of the evaluation. The program instructions may further adjust the predictive model, based on the evaluation. The program instructions may consider accuracy, fairness, robustness, and overall performance in the first and second set of predictive model metrics. The program instructions may include detecting a discrepancy between the first correlation coefficient and the second correlation coefficient. The program instructions may include a determination that a first predictive model metric caused the discrepancy. The program instructions may include employing, as part of the predictive model, a neural network to generate one or more predictions associated with the key performance indicator. The program instructions may include adjusting a weight and a bias of one or more neural network edges when generating the one or more predictions.

### BRIEF DESCRIPTION OF THE DRAWINGS

FIG. 1 illustrates an example computing environment, according to various embodiments.

FIG. 2 illustrates a flowchart of a method for evaluating the performance of a predictive model, according to various embodiments.

FIG. 3 illustrates an example neural network that may be specialized to predict transactions, according to various embodiments.

FIG. 4 illustrates a high-level block diagram of an example computer system that may be used in implementing embodiments of the present disclosure.

In the Figures and the Detailed Description, like numbers may refer to like elements. While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of predictive models, and more particularly, to evaluating the performance of a predictive model. While the present disclosure is not necessarily limited to such applications, various aspects of the disclosure may be appreciated through a discussion of various examples using this context.

Predictive models enjoy widespread use and myriad applications, and the complexity and size of the ingested datasets continue to increase. Large datasets provide challenges for predictive models. While a given metric for evaluating a predictive model may indicate a desirable level of overall performance, the predictive model may not always achieve that level of performance when the dataset is divided into subgroups. In other words, the prediction may not match or correlate a subset or facet of the ingested data.

A user or system administrator may desire to find correlations between metrics of a predictive model (e.g., accuracy, fairness, robustness, performance/throughput of scoring endpoint, etc.) and one or more key performance indicators (KPI). KPI may include quantifiable, outcome-based metrics that are used to measure performance. In some embodiments, KPI may include a number of transactions processed over a given time period, a value measurement for transactions processed during a given time period, the amount of resources used in processing a set of transactions, the average time taken for a transaction to be processed, etc.

In some embodiments, a transaction may include a computing function or set of computing functions. For example, one iteration of a set of data through a neural network may comprise a transaction. For example, a neural network configured to create a structured digital copy of a handwritten document may complete a “transaction” by ingesting an image of a handwritten document and outputting a digital copy which can be edited in a word processor.

Finding the correlation of a full set of transactions (or their corresponding KPIs) and the metrics used to evaluate a predictive model may include comparing the relevant KPI and predictive model metric.

However, finding a correlation between a subset of transactions and the predictive model metrics is a more difficult task, but may also yield valuable information. For example, in a scenario where a subset of transactions includes imbalanced data where one category is underrepresented, this may lead to a neural network achieving an acceptable level of performance (e.g., KPI) by simply ignoring a particular data field or class of data within the transaction(s).

As an example, a classifier type neural network may be configured to read and recognize handwritten text. Because “e” is the most common letter in the English alphabet, it would most likely represent the largest class of data in this example, and therefore one could expect the neural network to become adept, or accurate, at identifying a handwritten “e.” However, much less-common letters, such as “q,” may be seldom encountered. This may lead to a scenario of data imbalance, where the neural network may reach 99.9% accuracy when reading a given set of text, even though the neural network has “learned” to simply ignore the letter “q.” When reading a new set of text where “q” is prevalent (e.g., a poem of alliteration focusing on “q,” a set of mathematical equations where “q” is a common variable, etc.), the neural network may mistake “q” for “g,” leading to a plethora of errors and inaccuracies.

To overcome this problem, it would be advantageous to be able to “tag” data fields within transactions, such that a subset of transactions may be selected. For example, transactions containing a particular type of data field (e.g., select documents with “q” in them) may be selected so that KPI and predictive model metrics may be correlated using the subset of transactions. This correlation may be compared to the KPI and predictive model metrics for the entire set of transactions, to indicate whether the particular subset of transactions correlates to the overall KPI/metrics. In this way, a user or system administrator may discover ways to improve KPI.

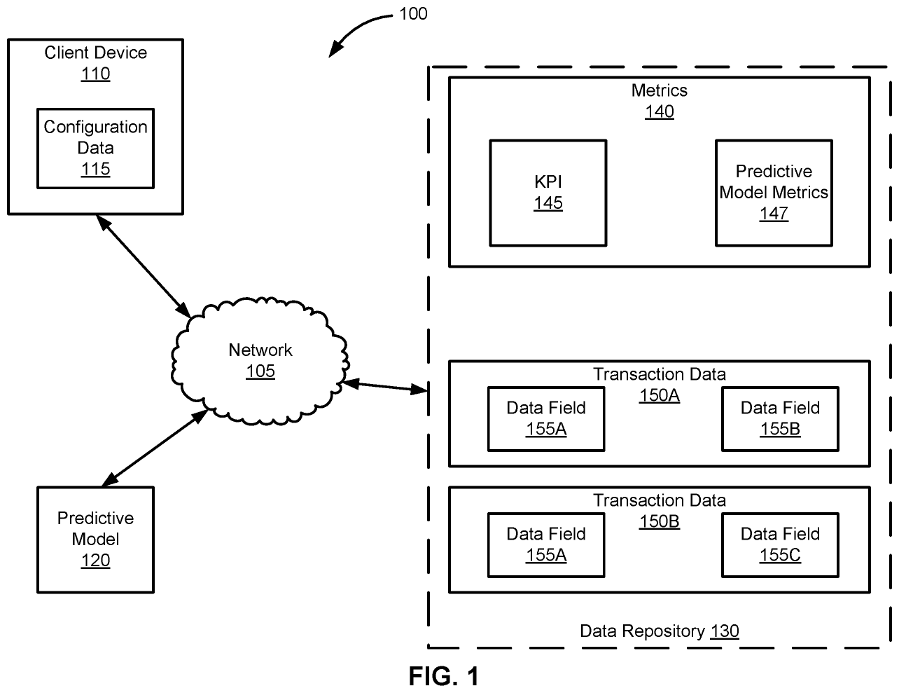

Turning now to FIG. 1, illustrated is an example computing environment 100, according to various embodiments. Example computing environment 100 may include network 105, client device 110, predictive model 120, and data repository 130.

In some embodiments, the client device 110, predictive model 120, and data repository 130 may reside in the storage of a single device, or may be distributed across the storage of a plurality of devices. In some embodiments, network 105 may be a wide area network (WAN), a local area network (LAN), an Internet, or an intranet. In some embodiments, the client device 110, predictive model 120, and data repository 130 may be communicatively coupled using a combination of one or more networks and/or one or more local connections. For example, client device 110 and predictive model 120 may be locally connected using a LAN, while data repository 130 may be remotely connected via the Internet.

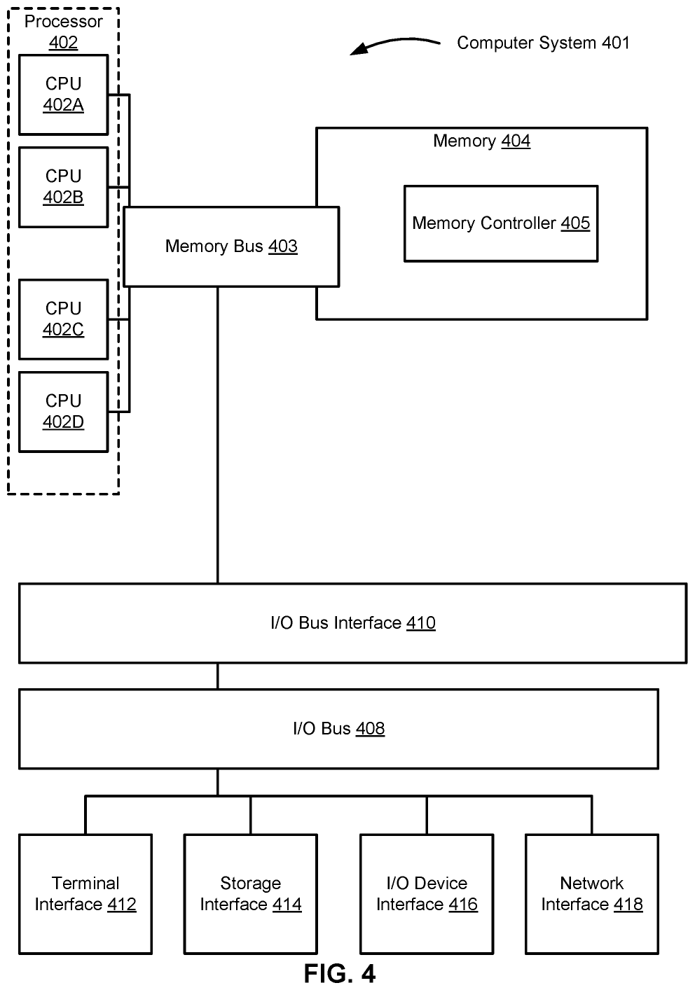

Client device 110 may be a computing system, such as computing system 401 of FIG. 4. Client device 110 may include configuration data 115. In some embodiments, configuration data 115 may include information to define metrics 140. A user may manipulate configuration data 115 using client device 110.

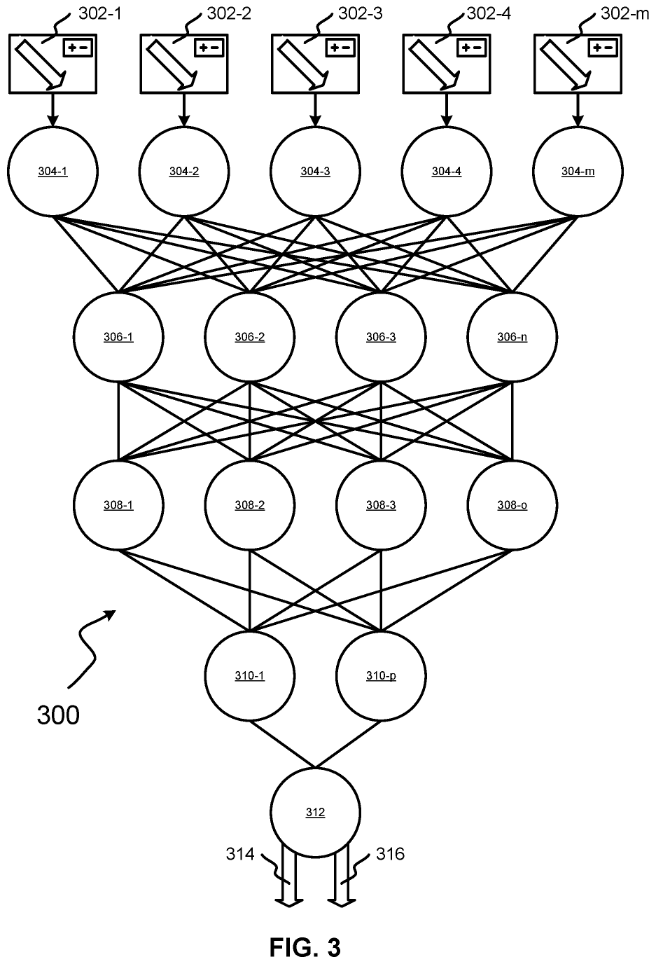

Predictive model 120 may be a neural network, such as the neural network described in FIG. 3. In some embodiments, predictive model 120 may be employed to predict KPI 145, based on transaction data 150A and 150B.

Data repository 130 may be a physical or virtual storage device and may use any suitable data structure or scheme for storing data. Data repository 130 may include metrics 140 and transaction data 150A and 150B.

Transaction data 150A and 150B (also referred to as “transaction data 150”) may include multiple data fields, such as data fields 155A-C (also referred to as “data fields 155”). In some embodiments, transaction data 150 may include any number of data fields 155. Data fields 155 may be “tagged” such that a user may select a subset of transaction data 150. For example, if a user were to select a subset of transaction data 150 by selecting a “tag” associated with data field 155B, then only transaction data 150A would be included in the selected subset. However, if a user were to select a subset of transaction data 150 by selecting the “tag” associated with data field 155A, then both transaction data 150A and transaction data 150B would be included in the selected subset.

In some embodiments, data fields 155 may include information describing aspects of transaction data 150. This may include, for example, a timestamp, a transaction value, a region from which the transaction originated, a transaction destination, a description of the subject matter of the transaction, etc.

Metrics 140 may include KPI 145 and predictive model metrics 147. As described herein, KPI 145 may include quantifiable, outcome-based metrics that are used to measure performance. In some embodiments, KPI 145 may represent a number of transaction data 150 processed over a given time period, a value measurement (e.g., currency value) of transaction data 150 processed during a given time period, the amount of resources used in processing a set of transaction data 150, the average time taken for transaction data 150 to be processed, etc.

As described herein, predictive model metrics 147 may include accuracy, fairness, robustness, performance/throughput of scoring endpoint, etc. In some embodiments, predictive model metrics 147 may be used to evaluate the performance of predictive model 120, which in turn may be used to predict KPI 145, based on transaction data 150. In some embodiments, predictive model 120 may further provide suggestions on how a user may increase KPI.

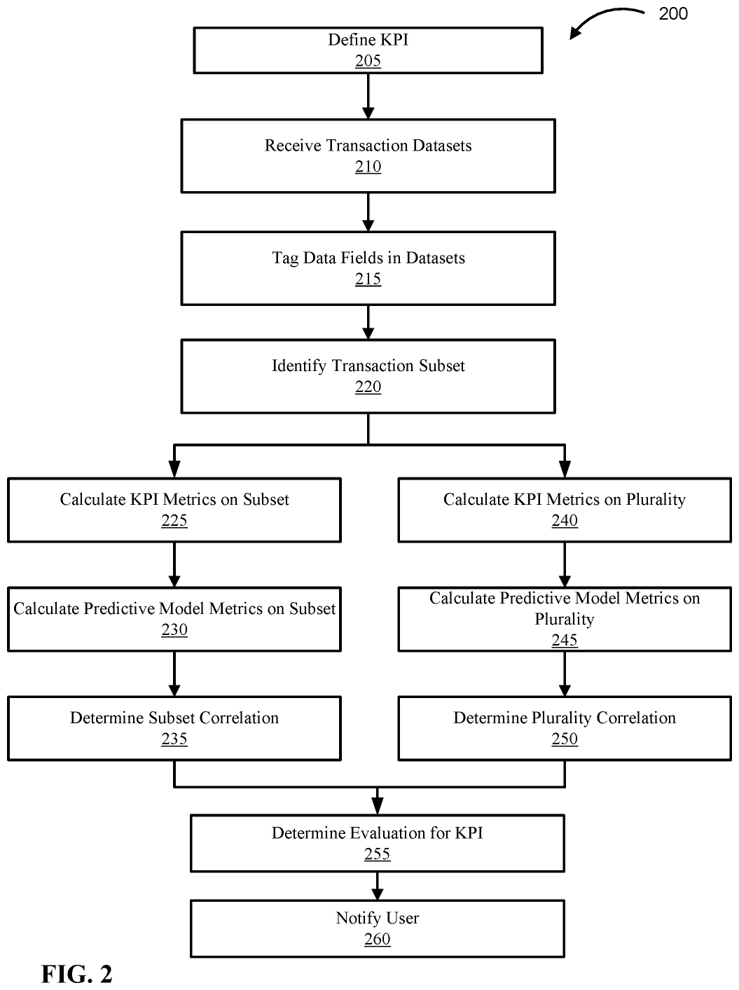

FIG. 2 illustrates a flowchart of a method 200 for evaluating the performance of a predictive model (e.g., predictive model 120 of FIG. 1), according to various embodiments. At 205, KPI is defined. In some embodiments, KPI may be defined by a user, as described herein.

At 210, transaction datasets are received. In some embodiments, transaction datasets may be substantially similar to transaction data 150, as described herein.

At 215, data fields within the datasets are tagged. In some embodiments, this may include logging all transaction data 150 as payload records and may allow transactions to be sorted according to presence/absence of one or more tags.

At 220, a transaction subset is identified. In some embodiments, this may include receiving a tag descriptor from a user and filtering a plurality of transactions to product a subset of transactions that have been tagged with the particular tag described.

At 225, KPI metrics are calculated on the subset of transactions, as described herein.

At 230, predictive model metrics are calculated on the subset of transactions, as described herein.

At 235, a subset correlation between the KPI and predictive model metrics is determined, and a correlation coefficient is produced to describe the correlation between the KPI and predictive model metrics that were calculated from the subset of transactions.

At 240, KPI metrics are calculated on the plurality of transactions (e.g., in some embodiments, all available transactions), as described herein.

At 245, predictive model metrics are calculated the plurality of transactions (e.g., in some embodiments, all available transactions), as described herein.

At 250, a plurality correlation between the KPI and predictive model metrics is determined, and a correlation coefficient is produced to describe the correlation between the KPI and predictive model metrics that were calculated from the plurality of transactions.

In some embodiments, parallelism techniques (e.g., single instruction multiple data (SIMD)) may be employed to perform 225 concurrently with 240, to perform 230 concurrently with 245, and to perform 235 concurrently with 250.

At 255 an evaluation for the KPI is determined. In some embodiments, the evaluation may include a comparison of the correlation coefficients to determine whether the metrics calculated from the plurality of transactions are representative of the metrics calculated from the subset of transactions.

As an example, if the metrics calculated from a global plurality of transactions produces a correlation coefficient of 0.8 at 250, and the metrics calculated from a local subset of transactions produces a correlation coefficient of 0.5, the evaluation may determine that the metrics calculated from the plurality of transactions is not representative of the metrics calculated from the subset of transactions. In this way, a user may identify a subset of transactions associated with a data imbalance, and may take steps to better train the predictive model (e.g., adjust weights/biases of neural network “edges”) and thereby increase KPI. In this way, trends and causes for trends among transaction datasets may be identified and leveraged to increase KPI without using statistical brute force methods.

At 260, a user is notified of the evaluation. This may include the production of a graph, chart, correlation coefficients, etc.

FIG. 3 depicts an example neural network 300 that may be specialized to predict transactions, in accordance with embodiments of the present disclosure. Inputs may include, for example, historical transaction data and/or subsets or transaction data, as described herein. In embodiments, neural network 300 may be a classifier-type neural network. Neural network 300 may be part of a larger neural network. For example, neural network 300 may be nested within a single, larger neural network, connected to several other neural networks, or connected to several other neural networks as part of an overall aggregate neural network.

Inputs 302-1 through 302-m represent the inputs to neural network 300. In this embodiment, 302-1 through 302-m do not represent different inputs. Rather, 302-1 through 302-m represent the same input that is sent to each first-layer neuron (neurons 304-1 through 304-m) in neural network 300. In some embodiments, the number of inputs 302-1 through 302-m (i.e., the number represented by m) may equal (and thus be determined by) the number of first-layer neurons in the network. In other embodiments, neural network 300 may incorporate 1 or more bias neurons in the first layer, in which case the number of inputs 302-1 through 302-m may equal the number of first-layer neurons in the network minus the number of first-layer bias neurons. In some embodiments, a single input (e.g., input 302-1) may be input into the neural network. In such an embodiment, the first layer of the neural network may comprise a single neuron, which may propagate the input to the second layer of neurons.

Inputs 302-1 through 302-m may comprise one or more samples of classifiable data. For example, inputs 302-1 through 302-m may comprise 10 samples of classifiable data. In other embodiments, not all samples of classifiable data may be input into neural network 300.

Neural network 300 may comprise 5 layers of neurons (referred to as layers 304, 306, 308, 310, and 312, respectively corresponding to illustrated nodes 304-1 to 304-m, nodes 306-1 to 306-n, nodes 308-1 to 308-o, nodes 310-1 to 310-p, and node 312). In some embodiments, neural network 300 may have more than 5 layers or fewer than 5 layers. These 5 layers may each be comprised of the same number of neurons as any other layer, more neurons than any other layer, fewer neurons than any other layer, or more neurons than some layers and fewer neurons than other layers. In this embodiment, layer 312 is treated as the output layer. Layer 312 outputs a probability that a target event will occur and contains only one neuron (neuron 312). In other embodiments, layer 312 may contain more than 1 neuron. In this illustration no bias neurons are shown in neural network 300. However, in some embodiments each layer in neural network 300 may contain one or more bias neurons.

Layers 304-312 may each comprise an activation function. The activation function utilized may be, for example, a rectified linear unit (ReLU) function, a SoftPlus function, a Soft step function, or others. Each layer may use the same activation function, but may also transform the input or output of the layer independently of or dependent upon the activation function. For example, layer 304 may be a “dropout” layer, which may process the input of the previous layer (here, the inputs) with some neurons removed from processing. This may help to average the data, and can prevent overspecialization of a neural network to one set of data or several sets of similar data. Dropout layers may also help to prepare the data for “dense” layers. Layer 306, for example, may be a dense layer. In this example, the dense layer may process and reduce the dimensions of the feature vector (e.g., the vector portion of inputs 302-1 through 302-m) to eliminate data that is not contributing to the prediction. As a further example, layer 308 may be a “batch normalization” layer. Batch normalization may be used to normalize the outputs of the batch-normalization layer to accelerate learning in the neural network. Layer 310 may be any of a dropout, hidden, or batch-normalization layer. Note that these layers are examples. In other embodiments, any of layers 304 through 310 may be any of dropout, hidden, or batch-normalization layers. This is also true in embodiments with more layers than are illustrated here, or fewer layers.

Layer 312 is the output layer. In this embodiment, neuron 312 produces outputs 314 and 316. Outputs 314 and 316 represent complementary probabilities that a target event will or will not occur. For example, output 314 may represent the probability that a target event will occur, and output 316 may represent the probability that a target event will not occur. In some embodiments, outputs 314 and 316 may each be between 0.0 and 1.0, and may add up to 1.0. In such embodiments, a probability of 1.0 may represent a projected absolute certainty (e.g., if output 314 were 1.0, the projected chance that the target event would occur would be 100%, whereas if output 316 were 1.0, the projected chance that the target event would not occur would be 100%).

In embodiments, FIG. 3 illustrates an example probability-generator neural network with one pattern-recognizer pathway (e.g., a pathway of neurons that processes one set of inputs and analyzes those inputs based on recognized patterns, and produces one set of outputs). However, some embodiments may incorporate a probability-generator neural network that may comprise multiple pattern-recognizer pathways and multiple sets of inputs. In some of these embodiments, the multiple pattern-recognizer pathways may be separate throughout the first several layers of neurons, but may merge with another pattern-recognizer pathway after several layers. In such embodiments, the multiple inputs may merge as well (e.g., several smaller vectors may merge to create one vector). This merger may increase the ability to identify correlations in the patterns identified among different inputs, as well as eliminate data that does not appear to be relevant.

In embodiments, neural network 300 may be trained/adjusted (e.g., biases and weights among nodes may be calibrated) by inputting feedback (e.g., user-defined transaction data, respectively) and/or input from a user to correct/force the neural network to arrive at an expected output. In embodiments, the impact of the feedback on the weights and biases may lessen over time, in order to correct for inconsistencies among user(s) and/or datasets. In embodiments, the degradation of the impact may be implemented using a half-life (e.g., the impact degrades by 50% for every time interval of X that has passed) or similar model (e.g., a quarter-life, three-quarter-life, etc.).

Referring now to FIG. 4, shown is a high-level block diagram of an example computer system 401 that may be configured to perform various aspects of the present disclosure, including, for example, method 200, described in FIG. 2. The example computer system 401 may be used in implementing one or more of the methods or modules, and any related functions or operations, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 414, an I/O (Input/Output) device interface 416, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may comprise one or more levels of on-board cache.

In some embodiments, the memory subsystem 404 may comprise a random-access semiconductor memory, storage device, or storage medium (either volatile or non-volatile) for storing data and programs. In some embodiments, the memory subsystem 404 may represent the entire virtual memory of the computer system 401, and may also include the virtual memory of other computer systems coupled to the computer system 401 or connected via a network. The memory subsystem 404 may be conceptually a single monolithic entity, but, in some embodiments, the memory subsystem 404 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 404 may contain elements for control and flow of memory used by the CPU 402. This may include a memory controller 405.

Although the memory bus 403 is shown in FIG. 4 as a single bus structure providing a direct communication path among the CPUs 402, the memory subsystem 404, and the I/O bus interface 410, the memory bus 403 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smart phone, mobile device, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for evaluating the performance of a predictive model, the method comprising:
defining a key performance indicator;
receiving a plurality of transaction datasets;
tagging a set of data fields in each transaction dataset of the plurality of transaction datasets;
identifying a subset of the plurality of transaction datasets according to a first data field tag;
calculating a first key performance indicator metric using the subset of the plurality of transaction datasets;
calculating a first set of predictive model metrics using the subset of the plurality of transaction datasets;
determining a first correlation coefficient between the first key performance indicator metric and the first set of predictive model metrics;
calculating a second key performance indicator metric using the plurality of transaction datasets;
calculating a second set of predictive model metrics using the plurality of transaction datasets;
determining a second correlation coefficient between the second key performance indicator metric and the second set of predictive model metrics;
determining an evaluation for the key performance indicator, based on the first and second correlation coefficient; and
notifying a user of the evaluation.

2. The method of claim 1, further comprising adjusting the predictive model, based on the evaluation.

3. The method of claim 1, wherein the first and second set of predictive model metrics include accuracy, fairness, robustness, and overall performance.

4. The method of claim 3, wherein determining the evaluation for the key performance indicator includes detecting a discrepancy between the first correlation coefficient and the second correlation coefficient.

5. The method of claim 4, wherein the evaluation includes a determination that a first predictive model metric caused the discrepancy.

6. The method of claim 5, wherein the predictive model employs a neural network to generate one or more predictions associated with the key performance indicator.

7. The method of claim 6, wherein generating the one or more predictions includes adjusting a weight and a bias of one or more neural network edges.

8. A computer program product for evaluating the performance of a predictive model, the computer program product comprising a computer readable storage medium having program instructions embodied therewith, the program instructions executable by a device to cause the device to:
define a key performance indicator;
receive a plurality of transaction datasets;
tag a set of data fields in each transaction dataset of the plurality of transaction datasets;
identify a subset of the plurality of transaction datasets according to a first data field tag;
calculate a first key performance indicator metric using the subset of the plurality of transaction datasets;
calculate a first set of predictive model metrics using the subset of the plurality of transaction datasets;
determine a first correlation coefficient between the first key performance indicator metric and the first set of predictive model metrics;
calculate a second key performance indicator metric using the plurality of transaction datasets;
calculate a second set of predictive model metrics using the plurality of transaction datasets;
determine a second correlation coefficient between the second key performance indicator metric and the second set of predictive model metrics;
determine an evaluation for the key performance indicator, based on the first and second correlation coefficient; and
notify a user of the evaluation.

9. The computer program product of claim 8, wherein the program instructions further cause the device to adjust the predictive model, based on the evaluation.

10. The computer program product of claim 8, wherein the first and second set of predictive model metrics include accuracy, fairness, robustness, and overall performance.

11. The computer program product of claim 10, wherein determining the evaluation for the key performance indicator includes detecting a discrepancy between the first correlation coefficient and the second correlation coefficient.

12. The computer program product of claim 11, wherein the evaluation includes a determination that a first predictive model metric caused the discrepancy.

13. The computer program product of claim 12, wherein the predictive model employs a neural network to generate one or more predictions associated with the key performance indicator.

14. The computer program product of claim 13, wherein generating the one or more predictions includes adjusting a weight and a bias of one or more neural network edges.

15. A system for evaluating the performance of a predictive model, comprising:
a memory with program instructions included thereon; and
a processor in communication with the memory, wherein the program instructions cause the processor to:
define a key performance indicator;
receive a plurality of transaction datasets;
tag a set of data fields in each transaction dataset of the plurality of transaction datasets;
identify a subset of the plurality of transaction datasets according to a first data field tag;
calculate a first key performance indicator metric using the subset of the plurality of transaction datasets;
calculate a first set of predictive model metrics using the subset of the plurality of transaction datasets;
determine a first correlation coefficient between the first key performance indicator metric and the first set of predictive model metrics;
calculate a second key performance indicator metric using the plurality of transaction datasets;
calculate a second set of predictive model metrics using the plurality of transaction datasets;
determine a second correlation coefficient between the second key performance indicator metric and the second set of predictive model metrics;
determine an evaluation for the key performance indicator, based on the first and second correlation coefficient; and
notify a user of the evaluation.

16. The system of claim 15, wherein the program instructions further cause the processor to adjust the predictive model, based on the evaluation.

17. The system of claim 15, wherein the first and second set of predictive model metrics include accuracy, fairness, robustness, and overall performance.

18. The system of claim 17, wherein determining the evaluation for the key performance indicator includes detecting a discrepancy between the first correlation coefficient and the second correlation coefficient.

19. The system of claim 18, wherein the evaluation includes a determination that a first predictive model metric caused the discrepancy.

20. The system of claim 19, wherein the predictive model employs a neural network to generate one or more predictions associated with the key performance indicator.
